(19) United States
(12) Patent Application Publication
(10) Pub. No.: US 2008/0238644 A1
(43) Pub. Date: Oct. 2, 2008

(54) Device for Detecting the Condition of a Tire on a Wheel

(76) Inventors: Klaus Voigtlaender, Wangen (DE); Lars Jakubowski, Abstatt (DE)

Correspondence Address: MICHAEL J. STRIKER, 103 EAST NECK ROAD, HUNTINGTON, NY, 11743, US

(21) Appl. No.: 10/591,072

(22) PCT Filed: Jan. 26, 2006
(86) PCT No.: PCT/EP2006/050476

§ 371 Date: Aug. 30, 2006

(30) Foreign Application Priority Data
Mar. 14, 2005 (DE) 10 2005 011 577.2

(51) Int. Cl. B60C 23/06

(52) U.S. Cl. 340/443

(57) ABSTRACT

A device for detecting the condition of a tire (2) on a wheel (3) of a vehicle (1), having at least one sensor (4) which ascertains condition data of the tire (2) and outputs them to a receiving unit of the vehicle (1), is propose in which at least one sensor (4) in the vehicle is provided, which ascertains values representing a distance (D1, D1′, D2, D3, D3′) to at least one target (5, 6, 7) affixed to the tire (2) and outputs them to an evaluation device (8), which from that ascertains condition data of the tire (2) (FIG. 1).

### PRIOR ART

The invention relates to a device for detecting the condition of a tire on a wheel, as defined in more detail by the preamble to claim 1.

In the industry, devices for ascertaining a tire condition are known that operate on various principles; as a rule, these devices are conceived for ascertaining the correct air pressure of the tire and ascertain condition data of the tire by means of sensors and output these data to a receiving unit of the vehicle and/or calculate or estimate condition data of the tire by means of control/regulating systems of the vehicle, such as an anti-lock brake system, an electronic stability program, or an electrohydraulic brake system.

Tire condition detection with systems on the vehicle that make use of rpm sensor information and vehicle information, for instance from systems connected to an engine/transmission controller, disadvantageously do not provide actual condition values of the tire but only indirect calculations and estimates. Besides the attendant inaccuracy, ascertaining tire condition in this way is also slow because of the system and, depending on the driving dynamics, requires a longer distance to be covered by the vehicle.

Tire condition detection using a sensor which outputs the ascertained values in wireless fashion to a receiving unit of the vehicle is described for instance in European Patent Disclosure EP 0 746 475 B1. A transponder is used here for detecting, storing in memory and sending tire condition parameter data for a vehicle tire; the transponder is connected to an energy supply and an antenna and in response to a query signal from a querying means on the vehicle outputs tire condition parameter data, particularly the air pressure and the temperature, to the querying means.

From German Patent Disclosure DE 199 40 086 A1, a method for identifying tires, especially aircraft tires, by means of integrated transponders and documentation of the usage data of the tire, including pressure and temperatures in the transponder, is known.

Such solutions to the problem, in which a battery-operated sensor, for instance, which is located on or in the tire forwards information, such as the internal tire pressure, either temperature-corrected or with an additional piece of temperature information, to a separate receiving unit of the vehicle, however, are disadvantageous in the sense that these sensors must always be recalibrated every time a tire is changed.

It is also known from the industry to provide a tire with magnetic elements and to detect a change in magnetic field upon rotation of the wheel by way of a suitable rpm sensor in the vicinity of the side of the tire. In this way, torsion of the side of the tire can be recognized.

However, in such a method it is disadvantageous that only special tires with the appropriate magnetic shafts may be used, and the amount of condition data of the tire that can thus be attained is low.

It is the object of the present invention to create a device for detecting the condition of a tire on a wheel of a vehicle with which the greatest possible amount of condition data of the tire can be ascertained reliably and quickly at little engineering effort or expense.

According to the invention, this is object is attained in a device of the type defined at the outset, having the characteristics of the body of claim 1.

### ADVANTAGES OF THE INVENTION

A device for detecting the condition of a tire on a wheel of a vehicle having at least one sensor, in an advantageous embodiment according to which at least one sensor in the vehicle is provided, which ascertains values representing a distance to at least one target affixed to the tire and outputs them to an evaluation device, which from that ascertains condition data of the tire, has the advantage first that locating the at least one sensor on the vehicle enables simple energy supply and data transmission.

Utilizing the distance information between the at least one sensor and a target affixed to the tire furthermore makes it possible, very quickly, to make reliable statements about many condition data of the tire.

For instance, monitoring the distance between the target on a side of the tire in the region of where the tire contacts the road surface and the sensor makes it possible to quickly make statements about a pressure condition or tire filling condition and a load condition of the tire, since shortening of this critical distance indicates either underfilling of the tire or a heavy load on the tire.

Moreover, the distance measurement makes it possible to make statements about the kind of load on the tire, such as a torsional load, and about a tire surface condition, since bulges, dents, fragmentation, and possibly nails driven into the tire are detectable via a distance measurement.

Depending on the sensor resolution, the condition of the tire tread can also be ascertained with the device of the invention, that is, the presence of a rated tread height or a reduced tread height.

With the use of distance information according to the invention, it is also possible to distinguish between a summer tire condition and a winter tire condition; to that end, the distance information can advantageously be combined by the evaluation device with a detection of the coefficient of friction.

By means of a periodic measurement signal, an imbalance condition of the tire that might be present can also be ascertained.

Besides monitoring the condition of the tire in the narrower sense, monitoring of rotating components that are connected to the tire is advantageously also possible, so that with the device of the invention, a rim condition can also be monitored for rim damage.

In an advantageous embodiment of the device of the invention, the at least one sensor may be designed such that it ascertains distance values and/or speed values of the at least one target.

With the speed values of the wheels, additional calculations may be made, such as calculating the wheel moments.

The at least one sensor may be disposed in static fashion on the vehicle chassis, for instance fixedly on an axle of the vehicle. However, the sensor may also be located on some component, such as a strut, that is dynamically connected to the vehicle chassis, with the advantage that a dynamic measurement can be performed in which dynamic changes in the travel state, such as acceleration, deceleration and cornering, can be tracked based on the tire deformation.

In a preferred embodiment of the invention, a first target is affixed to a side or rubber sidewall of the tire; the distance to such a target is highly conclusive, especially in ascertaining the filling condition of the tire and the load condition on the tire.

Alternatively or in addition, targets may also be affixed in the region of the heel zone or in the region of the shoulder zone at the transition to the running face of the tire; the latter makes it possible to monitor the width of the tire tread.

If a rotating reference measurement target is affixed as a further target to the wheel, then advantageously simple self-calibration of the at least one sensor for detecting the condition of a tire is possible. One such reference measurement target may for instance be a region of a bead of the rim.

The conclusiveness of a piece of condition information pertaining of the tire can be further enhanced by providing that a further target is a travel surface, and the height of the sensor compared to the travel surface is ascertained as the distance.

For detecting the distance to the at least one target, the sensor can operate by various known measurement principles; in particular, an electromagnetic sensor, such as a radar sensor, which furthermore ascertains a speed component of the detected measurement range, is advantageous. However, the sensor may also be embodied as an optical sensor, in particular a lidar sensor or a picture-taking device, or as an acoustic sensor, such as an ultrasound sensor.

Upon a measurement of distances to a plurality of targets, it may be provided that these distances are detected simultaneously in a predetermined angular range.

In an advantageous embodiment of the invention, however, either mechanical pivoting to various angular ranges or electronic switching may be provided.

For instance, if a radar sensor is used, the entire distance range can be scanned with a fixed antenna, or by using a scanning antenna, an angular resolution can be generated via a patch array or mechanical pivoting.

Optical systems that are based on picture-taking, for instance by means of video, can be designed in analog form; for detecting various angular ranges, the use of mirrors is also conceivable.

The condition data of the tire ascertained with the device of the invention can be made available by the evaluation device, in an advantageous embodiment of the invention, to a network with control/regulating systems of the vehicle connected to it.

These control/regulating systems, in the case of a motor vehicle, can act on the vehicle drive and transmission or on individual equipment characteristics or safety and information modules. Examples of such control/regulating systems are an anti-lock brake system, an electrohydraulic brake system, which is a combination of an electronic and a hydraulic brake, traction control, an electronic stabilization program, automatic tire pressure monitoring with automatic filling, triggering of an axle air shock absorber, electronic shock absorber control, light regulation, illumination width regulation, and vehicle-to-vehicle communications or vehicle-to-control-center communications, with which remote diagnosis can be made in the case of repair or a breakdown.

To indicate to the driver and/or a maintenance worker that there is a deviation in a tire condition from a rated condition and this deviation requires handling by the driver or maintenance worker, it is expedient if the evaluation device outputs a corresponding signal to an optical and/or acoustical and/or haptic display device of the vehicle.

The device of the invention can also cooperate with a memory and receiver device, known per se, in which by means of transponder technology, for instance, data are forwarded from a transmitter in the tire to a receiver in the vehicle. In this way, tire-specific data, which relate for instance to the make, the manufacture, and the allowable maximum speed of the effected tire, or also additional pressure and temperature values, can be forwarded.

From a memory device of the tire, data ascertained over the life of the tire can be called up; thus even after a tire has been changed these data are available and provide information which is undetectable via a purely in-vehicle ascertainment of the tire condition.

Along with the condition data ascertained by the distance measurement according to the invention, information pertaining to the tire can thus be comprehensively obtained, information that can be made available to the network of control/regulating systems of the vehicle for the sake of a situation-optimized mode of operation of the vehicle.

Although the device of the invention proves to be highly advantageous particularly in the case of a motor vehicle, it is not limited to motor vehicles, but can be used in all wheeled means of transportation. Particularly for aircraft, in which for safety reasons reliable tire diagnosis is of great significance, a device for detecting the condition of a tire according to the invention can be advantageous.

Further advantages and advantageous features of the subject of the invention can be learned from the description, drawings and claims.

### DRAWINGS

One exemplary embodiment of a device according to the invention for detecting the condition of a tire, with two options for the location of sensors, is shown schematically and in simplified form in the drawings and will be described in further detail in the ensuing description. Shown are:

FIG. 1, in a simplified cross section, a detail of a wheel suspension of a motor vehicle, where a device according to the invention for detecting the condition of a tire is provided on the wheel shown of the motor vehicle;

FIG. 2, two possible mounting positions of a sensor of the device according to the invention in the case of a wheel suspension of a vehicle;

FIG. 3, a graph that shows the relationship of signal amplitudes to a distance between a sensor of the device of the invention and a detected target on the tire; and

FIG. 4, a flow chart of a method for detecting the condition of a tire using the device of the invention.

### DESCRIPTION OF THE EXEMPLARY EMBODIMENT

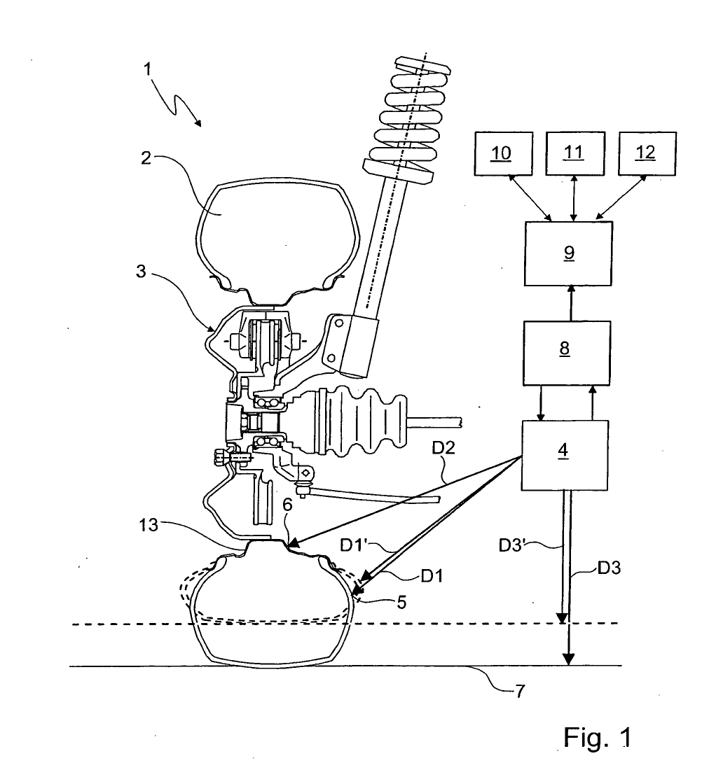

In FIG. 1, in a motor vehicle 1, a device for detecting the condition of a tire 2 on a wheel 3 of the motor vehicle 1 is shown, with a sensor 4 provided on the vehicle, which sensor, to detect a condition or specific condition data of the tire 2, ascertains at least one distance to a target affixed to the tire 2 and outputs it to an evaluation device 8.

The sensor 4, which in the present example is embodied as a radar sensor, measures a distance to a first target 5, affixed to a side of the tire 2; reference numeral D1 represents a distance for a defined rated condition of the tire 2, and reference numeral D1′ represents a shortened distance, for instance in the event of an underpressure condition of the tire 2 and of a deformed tire contour shown in dashed lines.

A second distance D2 ascertained by the sensor 4 represents a reference distance between the sensor 4 and a reference measurement target 6 on the wheel 3; the reference measurement target 6 in this case is affixed to a bead of a rim 13 of the wheel 3.

The bead of the rim 13 is especially well suited to affixing a reference measurement target, since in this region of the rim 13, unless the vehicle has an accident, no changes in form or position are to be expected.

The height of the sensor 4 relative to the travel surface 7, the latter representing a further target, is also ascertained as a further distance; reference numeral D3 represents a distance in the rated condition of the tire 2 and reference numeral D3′ represents a shortened distance, in the underpressure condition of the tire 2 represented by a dashed-line tire contour.

As can be seen from FIG. 1, the distances D1 and D3 between the sensor 4 and the target 5 on the tire 2, and between the sensor 4 and the travel surface 7 as shown in dashed lines in the case of underfilling of the tire 2, are shortened to the corresponding distances D1′ and D3′, respectively.

From the distance values or the changes in the distance values, the evaluation device 8 ascertains condition data of the tire 2 and makes them available to a network 9, here embodied as a CAN bus system, with control/regulating systems 10, 11 connected to it and to display devices 12 of the motor vehicle 1.

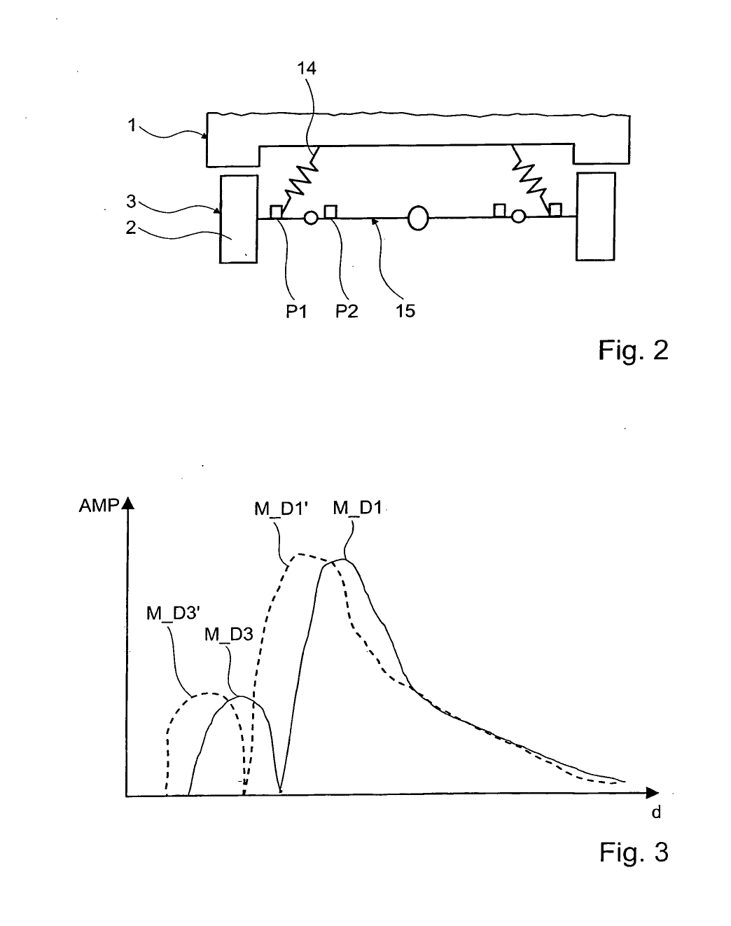

In FIG. 2, two possible locations of the sensor 4 are shown; a first position P1 shows the location of the sensor 4 on a component oscillating dynamically with the wheel 3 and is connected to the vehicle chassis 15, for instance in this case a strut 14. This position P1 of the sensor has the advantage that it is located close to the targets and makes a dynamic measurement possible.

A stationary location of the sensor 4 at a further position P2 is also shown; this position may be provided on a rigid axle element of the vehicle chassis 15. From the position P2, objective distance measurements of the sensor 4 to the targets 5, 6, 7 are possible.

In FIG. 3, measurement profiles are shown as amplitudes AMP over a distance d; in principle, reference symbol M_D1 represents a measurement profile that produces the distance D1 between the sensor 4 and the target 5 on the side of the tire 2 in the rated condition of the tire 2; M_D1 represents a measurement profile that produces the distance D1′ between the sensor 4 and the target 5 in the case of underfilling of the tire 2; M_D3 represents a measurement profile that produces the distance D3 between the sensor 4 and the travel surface 7 in the rated condition of the tire 2; and M_D3′ represents a measurement profile that produces the distance D3′ between the sensor 4 and the travel surface 7 in the case of underfilling of the tire 2.

The shift in the measurement profile M_D1 to M_D1′ and the measurement profile M_D3 to M_D3′ here unambiguously indicates tire deformation; from the tire deformation, by means of a suitable algorithm based on a dynamic detection of the shift in the measurement profiles, the underfilled condition of the tire 2 is detectable.

As can be seen from the graph in FIG. 3, the measurement profiles M_D1 and M_D3 on the one hand and M_D1′ and M_D3′ on the other together each form a respective curve with two pronounced maximum values of markedly different magnitude and minimum values in the form of zero points.

In the use in this case of a sensor 4 embodied as a radar sensor, which ascertains both the distance to the measurement target 5 on the tire and to the travel surface 7 and outputs a speed component of the region in question of the side of the tire 2 to the evaluation device 8, it is possible with knowledge of the geometries and a corresponding association, as a function of fixed distance cells, to associate the greater maximum value with the curve of the measurement profile M_D1 and M_D1′ of the measurement of the distance to the measurement target 5 on the tire 2, and to associate the lesser maximum with the curve of the measurement profile M_D3 and M_D3′ of the measurement of the distance to the travel surface 7.

A clear distinction between the measurement profiles or distance spaces is obtained in the present case from the zero points that occur every time a switchover of the radar sensor 4 to the applicable target is made.

As can also be learned from the measurement profiles M_D1, M_D1′, M_D3, M_D3′ of FIG. 3, these each have a strong, virtually continuous drop, beginning at a maximum and extending to a lower distance range, while the gradient of the measurement profiles to a greater distance range can have a considerably shallower course, as can be seen particularly from the measurement profiles M_D1 and M_D1′. This shows that the steep drop on the left in the curves M_D1, M_D1′, M_D3, M_D3′ represents a sensitive measurement parameter that can be used for extrapolation and interpolation, and toward greater distances d, interference parameters may possibly occur.

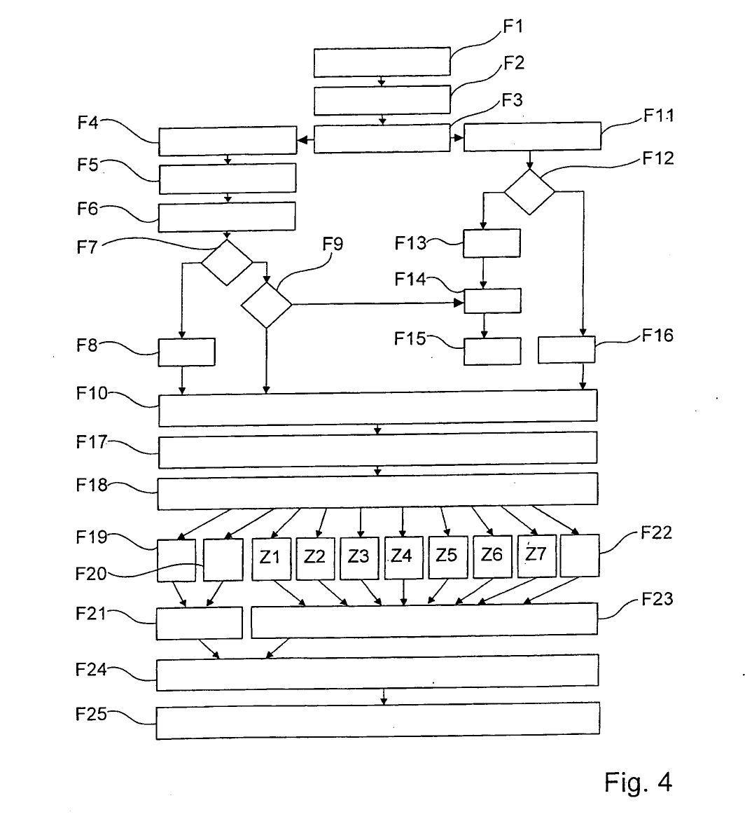

Performing a detection of the condition of the tire 2 can be done, in the case of the device of the invention, with a method in accordance with the flow chart shown in FIG. 4.

In the chart shown in FIG. 4, the amplitudes AMP over the distances are first plotted in accordance with the measurement profiles of FIG. 3, in a first function F1.

In the next function F2, the maximum and minimum values of the measurement profiles are determined, and in a function F3, it is investigated whether the outcomes or measurement profiles, such as in the present example the measurement profiles M_D1′ and M_D3′, are congruent with associated rated values or rated measurement profiles stored in a memory unit, namely in the present case the measurement profiles M_D1 and M_D3, respectively.

If there is more than one maximum value, an evaluation of the signals for the respective maximum values is done in a further function F4; this is followed in the next function F5 by a comparison of the maximum values with rated values or empirical values, which may be static and dynamic values for the rated condition.

Next, in a further function F6 of the flow chart, a dynamic adaptation of the rated values may be done.

In a further function F7, it is checked whether the rated values for the distance D1 to the measurement target 5 on the side of the tire 2 and the distance D3 to the travel surface 7 are matched. If such a match is ascertained in the distinguishing function F7, then in the next function F8 it is output that the outcomes or measurement profiles can be used by an algorithm of a control unit of the motor vehicle.

Furnishing the information or results for use by control/regulating systems, connected for instance to an on-board electrical system of the vehicle, is done in a further function F10.

If a deviation from the rated values is ascertained in the distinguishing function F7, then in the next distinguishing function F9, a selection among the values is made with regard to whether they can be used, or whether the signals are not usable further.

If the signals can continue to be used, then for furnishing use a jump is made to the corresponding function F10. If the deviations are greater than a predetermined threshold, and thus are defined as not further usable, then in the next function F14 it is output that the signal is not usable.

Next, in a following function F15, emergency operation of the system is started, and this information is output to the function F10 for use of the measurement profiles by the network of the vehicle and of the regulator algorithms of the connected control/regulating systems.

If in the function F3 in the investigation of the measurement profiles for congruence with the rated values a deviation is found which is defined for a defect in the sensor, for instance if only one maximum value is detectable, then an emergency operation evaluation is started with a function F11, instead of performing the evaluation of the signals for maximum values in the function F4.

In the emergency operation evaluation, it is checked in a distinguishing function F12 whether an ascertained deviation of a measurement profile from rated values is evaluatable or is implausible. If the ascertained deviations are outside a defined plausibility range, then in the next function F13 it is output that a possible sensor defect exists, and a jump is made to function F14, which outputs the fact that the signal is not usable, whereupon an emergency system operation is started in accordance with function F15, and this information is output to the function F10 for use of the measurement profiles by the connected regulator algorithms in the vehicle.

If in the emergency operation evaluation in function F12 it is ascertained that an existing change or measurement profile deviation is evaluatable, then in a subsequent function F15 the information that there is a tire defect can be generated and output to the function F10 for use of the information by the control/regulating systems of the vehicle.

Once the information in accordance with the function F10 is made available to different control/regulating systems by way of the on-board electrical system of the motor vehicle, this information is read in by one of these systems in a subsequent function F17; for instance, a comparison is made with empirical values or standard values stored in memory in a database, and the existing information is checked for deviations.

Depending on the outcome of the processing of the information in the function F17, in the next function F18 a reaction by the particular evaluation device or control unit involved takes place.

The latter can, in the case of dynamic measurement by the sensor 4, for instance, output the information in the next function F19 that dynamic changes in the travel condition, such as acceleration, deceleration and cornering, exist.

Moreover, in a function F20, the calculation of the wheel moments can be started; both the statements about dynamic changes in the travel condition of the function 19 and the wheel moments of the function 20 can be processed in the next function F21, which represents a regulating algorithm for adjusting the travel speed. The speed governing is thus based on qualitative signals and secure information.

The applicable evaluation device or control unit can moreover allocate the existing information, as condition data of the tire, with a defined condition and can output this condition as a signal.

In the flow chart of FIG. 4, an imbalanced condition of the tire is shown as condition Z1; a pressure condition of the tire is shown as condition Z2; a tread condition of the tire is shown as condition Z3; a tire surface condition is shown as condition Z4; a summer tire/winter tire condition is shown as condition Z5; an existence of an illegal use of tires or rims is shown as condition Z6; and a rim condition is shown as condition Z7, as examples.

Moreover, in a function F22, as a reaction to the function F18, a self-calibration of the sensor by reference to the rim can be requested.

Depending on the condition output, in the next function F23 provisions associated with the applicable condition are initiated, such as an emergency operation program, the activation of optical and/or acoustical and/or haptic warning signals, an automatic speed limitation, a change in the braking characteristic, a change in the engine characteristic, or an adaptation of acceleration conditions to the road surface.

Based on the provisions made, in a further function F24 a selection of hypotheses and an allocation of the provisions to categories is done; for example, prioritizing of individual provisions can be defined.

Finally, in a function F25, a recursion of the above-described sequence takes place for a new measurement cycle.

1-15. (canceled)

16. A device for detecting a condition of a tire on a wheel of a vehicle; comprising a receiving unit adapted to be provided in a vehicle; at least one sensor which ascertains condition data of the tire and outputs them to said receiving unit; an evaluation device, said at least one sensor being adapted to be provided in the vehicle and configured to ascertain values representing a distance to at least one target element affixed to the tire and output them to said evaluation device which from that ascertains condition data of the tire, wherein said at least one target element includes a first target adapted to be affixed to one side of the tire and a further target which is a rotating reference measurement target on the wheel.

17. A device as defined in claim 16, wherein said further target is a travel surface, and a height of said at least one sensor above the travel surface is ascertained as the distance.

18. A device as defined in claim 16, wherein said at least one sensor is configured to ascertain speed values of said at least one target element.

19. A device as defined in claim 16, wherein said evaluation unit is configured so that from the values selected from the group consisting of a distance values, speed values, and both, said evaluation unit ascertains variables which are compared with rated values; and further comprising a memory unit which stores the rated values.

20. A device as defined in claim 19, wherein said evaluation unit is configured so that it ascertains amplitudes of the distance, maximums of which amplitudes are compared with rotated values stored in memory.

21. A device as defined in claim 16, wherein said at least one sensor is adapted to be located in static fashion on a vehicle chassis.

22. A device as defined in claim 16, wherein said at least one first sensor is adapted to be located on a component that is connected dynamically to a vehicle chassis.

23. A device as defined in claim 22, wherein said at least one sensor is adapted to be located on a strut that is connected dynamically to a vehicle chassis.

24. A device as defined in claim 16, wherein said at least one sensor is a sensor selected from the group consisting of an electromagnetic sensor, an optical sensor, and an acoustic sensor.

25. A device as defined in claim 24, wherein said electromagnetic sensor is configured as a radar sensor.

26. A device as defined in claim 24, wherein said optical sensor is a sensor selected from the group consisting of a lidar sensor and a picture-taking device.

27. A device as defined in claim 24, wherein said acoustic sensor is configured as an ultrasound sensor.

28. A device as defined in claim 16, wherein said at least one sensor is configured to ascertain the condition data of the tire selected from the group consisting of tire pressure condition, tire load condition, rod, tire tread condition, summer tire condition, winter tire condition, and tire imbalance condition.

29. A device as defined in claim 16, wherein said at least one sensor is configured to ascertain condition data of the tire which is a rim condition.

30. A device as defined in claim 16, wherein said evaluation device is configured so as to make condition data of the tire available to an element selected from the group consisting of a network having control/regulating systems connected to it, at least one display device of the vehicle, and both.

31. A device as defined in claim 16, wherein the device for detecting a condition of a tire on a wheel of a vehicle is configured as a device for detecting a condition of a tire on a wheel of a motor vehicle.

32. A device as defined in claim 16, wherein the device for detecting a condition of a tire on a wheel of a vehicle is configured as a device for detecting a condition of a tire on a wheel of an aircraft.
